(19) United States
(12) Patent Application Publication
(10) Pub. No.: US 2026/0003579 A1
(43) Pub. Date: Jan. 1, 2026

(54) INTELLIGENT AND CONTEXT-AWARE SOFTWARE FEATURE DEVELOPMENT TASK SEGMENTATION IN A MULTI-LAYER SERVICE-ORIENTED PLATFORM

(71) Applicant: ATLASSIAN PTY LTD., Sydney (AU)

(72) Inventors: Cameron McKenzie, Hobart (AU); Arbaaz Baba, Srinagar (IN); Aishwarya Bhardwaj, Meerut (IN); Syed Ghouse Masood, Sydney (AU)

(21) Appl. No.: 18/755,163

(22) Filed: Jun. 26, 2024

(51) Int. Cl. G06F 8/33; G06F 8/35

(52) U.S. Cl. CPC G06F 8/33; G06F 8/35

(57) ABSTRACT

Intelligent and context-aware software feature development task segmentation in a multi-layer service-oriented platform is provided. A task segmentation request for an issue document hosted by a software application may be received. One or more context data sources for the issue document may be identified. Context data for the issue document may be aggregated based on the one or more context data sources. One or more candidate software feature development sub-tasks may be generated for the issue document using a large language model and based on the context data. One or more software feature development sub-tasks may be selected from the one or more candidate software feature development sub-tasks in response to receiving an indication of a candidate software feature development sub-task selection. One or more child issue documents corresponding to the one or more software feature development sub-tasks that is selected may be generated within the software application.

### TECHNICAL FIELD

The present disclosure relates generally to issue tracking and management in a software application framework; particularly to intelligent and context-aware software feature development task segmentation in an issue tracking system associated with a multi-layer service-oriented platform.

### BACKGROUND

Issue tracking and management is an essential aspect of software development and IT service management in a software application framework. Applicant has identified many deficiencies and problems associated with breaking down issues into sub-issues in issue tracking and management tools. Through applied effort, ingenuity, and innovation, these identified deficiencies and problems have been solved by developing solutions that are in accordance with the embodiments of the present invention, many examples of which are described in detail herein.

### BRIEF SUMMARY

Embodiments of the present disclosure relate to intelligent and context-aware software feature development task segmentation in issue tracking systems. In accordance with one aspect a computer-implemented method for intelligent and context-aware software feature development task segmentation in a multi-layer service-oriented platform is provided, the computer-implemented method comprising receiving a task segmentation request for an issue document hosted by a software application; identifying one or more context data sources for the issue document; aggregating context data for the issue document based on the one or more context data sources; generating, using a large language model and based on the context data, one or more candidate software feature development sub-tasks for the issue document by applying the context data to the large language model; selecting one or more software feature development sub-tasks from the one or more candidate software feature development sub-tasks in response to receiving an indication of a candidate software feature development sub-task selection; and generating one or more child issue documents within the software application corresponding to the one or more software feature development sub-tasks that is selected.

In some embodiments, generating the one or more candidate software feature development sub-tasks for the issue document using the large language model comprises generating a few-shot model prompt comprising the context data, wherein the context data comprises at least a portion of the issue document; and providing the few-shot model prompt to the large language model.

In some embodiments, the large language model is a multimodal large language model.

In some embodiments, the computer-implemented method further comprises providing, via a task segmentation user interface associated with the software application, the one or more candidate software feature development sub-tasks to a user; and receiving the indication of the candidate software feature development sub-task selection via the task segmentation user interface.

In some embodiments, the computer-implemented method further comprises refining the one or more software feature development sub-tasks selected to generate one or more refined software feature development sub-tasks, wherein the one or more child issue documents comprises the one or more refined software feature development sub-tasks.

In some embodiments, the one or more context data sources comprise a description field of the issue document.

In some embodiments, the one or more context data sources comprise a domain-specific entity relation graph associated with the issue document.

In some embodiments, aggregating the context data comprises identifying one or more entities associated with the issue document by traversing the domain-specific entity relation graph; and identifying at least a portion of the context data based on entity data of the one or entities.

In some embodiments, the one or more context data sources comprise one or more content pages of a second software application associated with the software application hosting the issue document.

In some embodiments, the issue document comprises one or more links to the one or more content pages of the second software application, wherein aggregating the context data comprises accessing the one or more content pages of the software application via the one or more links; and parsing the one or more content pages to identify at least a portion of the context data.

In some embodiments, the one or more context data sources comprise one or more visual media objects associated with the issue document.

In some embodiments, identifying the one or more context data sources comprises identifying at least a portion of the one or more context data sources using a machine learning model and based on the issue document.

In some embodiments, identifying the one or more context data sources comprises identifying at least a portion of the one or more context data sources based on user input, wherein the user input is received via a task segmentation user interface associated with the software application.

In some embodiments, the context data comprises one or more of (i) a summary of the issue document, (ii) a description of the issue document, (iii) an issue type of issue document, (iv) parent issue data, (v) user data, or (vii) entity data of one or more entities associated with the issue document.

In some embodiments, the computer-implemented method further comprises receiving indication of a child issue document selection; and causing rendering of a user interface to a client computing device display, wherein the user interface comprises a child issue document from the one or more child issue documents corresponding to the child issue document selection.

In accordance with another aspect, an apparatus for intelligent and context-aware software feature development task segmentation in a multi-layer service-oriented platform is provided, the apparatus comprising at least one processor and at least one memory including program code, the at least one memory and the program code configured to, with the at least one processor, cause the apparatus to at least receive a task segmentation request for an issue document hosted by a software application; aggregate context data for the issue document based on the issue document and one or more external context data sources associated with the issue document; generate, using a large language model and based on the context data, one or more candidate software feature development sub-tasks for the issue document by applying the context data to the large language model; and generate one or more child issue documents within the software application corresponding to the one or more candidate software feature development sub-tasks.

In some embodiments, the at least one memory and the program code configured to, with the at least one processor, cause the apparatus to generate the one or more candidate software feature development sub-tasks for the issue document using the large language model by generating a few-shot model prompt comprising the context data; and providing the few-shot model prompt to the large language model.

In some embodiments, the large language model is a multimodal large language model.

In some embodiments, the one or more context data sources comprise a description field of the issue document.

In accordance with another aspect, at least one non-transitory computer-readable storage medium for intelligent and context-aware software feature development task segmentation in a multi-layer service-oriented platform in provided, the at least one non-transitory computer-readable storage medium having computer coded instructions configured to, when executed by at least one processor receive a task segmentation request for an issue document hosted by a software application; aggregate context data for the issue document based on the issue document and one or more external context data sources associated with the issue document; generate, using a large language model and based on the context data, one or more candidate software feature development sub-tasks for the issue document by applying the context data to the large language model; generate one or more refined software feature development sub-tasks based on the one or more candidate software feature development sub-tasks; and generate one or more child issue documents within the software application corresponding to the one or more refined software feature development sub-tasks.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example task segmentation system architecture within which at least some embodiments of the present disclosure may operate,

FIG. 2 is a block diagram of a task segmentation apparatus in accordance with at least some embodiments of the present disclosure.

FIG. 3 is a block diagram of an example client computing device structured in accordance with at least some embodiments of the present disclosure.

FIG. 4 illustrates a visualization of an example data environment for intelligent and context-aware software feature development task segmentation in accordance with at least some embodiments of the present disclosure.

FIGS. 5A-C depict at least a partial view of example task segmentation user interface configured in accordance with at least some embodiments of the present disclosure.

FIG. 6 is a flow chart diagram of an example process for intelligent and context-aware software feature development task segmentation in accordance with at least some embodiments of the present disclosure.

FIG. 7 illustrates an example signal diagram for intelligent and context-aware software feature development task segmentation in accordance with at least some embodiments of the present disclosure.

### DETAILED DESCRIPTION OF SOME EMBODIMENTS

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Overview

Some embodiments of the present disclosure address technical problems associated with segmenting software feature development tasks in issue tracking software applications associated with a multi-layer service-oriented platform involving interdependent services and microservices that support a myriad of software features, applications, and software development functions. Segmenting a software feature development task into smaller manageable units (e.g., sub-tasks) is essential for charting a clear path through any software feature development work flow. For example, segmenting a software feature development task into smaller units helps ensure important details are not missed, allows for precise progress monitoring of the software feature development task, allows for responsibilities to be assigned, and improves overall planning and task management.

However, because smaller units of work in which a software feature development task may be segmented is often not readily apparent and may involve accessing and analyzing a vast amount of data from multiple software applications (including external or third party software applications), it can be difficult to accurately and efficiently segment software feature development tasks into smaller units. This difficulty is exacerbated when one considers the complexity of some software feature development tasks.

According to various embodiments, there is provided a system, method, apparatus, and/or a computer program that is configured to leverage context associated with a software feature development task to automatically and intelligently segment the software feature development task into software feature development sub-tasks.

In example embodiments, the intelligent software feature development task segmentation process may include receiving a task segmentation request associated with an issue document, programmatically inferring and recommending relevant software feature development sub-tasks and generating child issue documents corresponding to the software feature development sub-tasks. The issue document may exist within or otherwise may be supported by a software application such as an issue tracking software application. An example of an issue tracking software application is Jira Software® by Atlassian, Inc. The issue document may include a natural language-based description of the software feature development task, link(s) to features of one or more other software applications, and/or the like.

In example embodiments, generative artificial intelligence (AI) employing one or more large language models is leveraged to generate the software feature development sub-tasks for the issue document based on the issue document and context data associated with the issue document. The large language model(s) may be configured to receive the issue document (or at least a portion thereof) and the context data via, for example, a few-shot prompt and process the issue document with the context data to generate one or more candidate software feature development sub-tasks for the issue document.

Example embodiments extract context data based on the issue document (e.g., source issue context data) and augment with context data extracted from external context data sources such as visual media objects (e.g., loom videos, or the like), content pages of other software applications, entities associated with the issue document, and/or the like. The large language model(s), for example, may be a multimodal large language models capable of analyzing and/or processing various types of input. Example context data that may be provided to the large language model may include a summary of the software feature development task defined by the issue document, a description of the software feature development task defined by the issue document, an issue type of the issue document, parent issue data (e.g., data from a parent issue document associated with the issue document), child issue data (e.g., data from a child issue document associated with the issue document), user data, Loom video, content page of a collaboration software application (such as Confluence® by Atlassian, Inc.), and/or the like. The user data may include, for example, a user identifier associated with a user, information about the user associated with the user identifier, and/or other data associated with the user.

In example embodiments, at least one candidate software feature development sub-task may be selected from the one or more candidate software feature development sub-tasks generated by the large language model in response to receiving indication of a selection by a user via a task segmentation user interface. Alternatively or additionally, in some example embodiments, a selected software feature development sub-task may be refined based on user input. In some examples, refining a selected software feature development sub-task may comprise editing the selected software feature development sub-task in accordance with user preference. In example embodiments, one or more child issue documents corresponding to the selected and/or refined candidate software feature development sub-tasks is generated within the software application (e.g., issue tracking software application, or the like) for access by a user via one or more user interfaces associated with the software application.

Accordingly, embodiments of the present disclosure provide various technical improvements to issue tracking systems. For example, by providing software feature development sub-tasks for an issue document based on a robust and relevant context data aggregated from one or more context data sources, embodiments of the present disclosure improve the relevancy and accuracy of the software feature development sub-tasks generated for an issue document. This, in turn, obviates the need for a user to navigate through multiple resources (e.g., other applications, features, etc.) to obtain the required information. In this regard, embodiments of the present disclosure improve at least computing resource efficiency as well as user efficiency.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client computing device,” “computing device,” “client computing entity” “network device,” “computer,” “user equipment,” and similar terms may be used interchangeably to refer to a computer comprising at least one processor and at least one memory. In some embodiments, the client computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” may refer to computer hardware and/or software that is configured to access a service made available by a server. The server is often, but not always, on another computer system, in which case the client accesses the service by way of a network. Embodiments of client computing devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” refers to hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client computing devices. Non-limiting examples of an application comprise issue tracking software applications, project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product.

The term “multi-layer service-oriented platform” refers to a complex network computing environment associated with a multitude of computing devices, applications, services, and microservices. For example, in some embodiments, a multi-layer service-oriented platform includes dozens of applications that are supported by 1000+ services operating within a cloud-based platform. Example multi-layer service-oriented platforms may comprise a federated network of computing devices, and/or a plurality of database platforms (e.g., servers, hard-drives, etc.). Applications and services or microservices of example multi-layer service-oriented platforms may be hosted by internal resources or external resources. Multi-layer service-oriented platforms may support multiple applications that are configured for the collection of information (e.g., in the form of application data objects), storing of information collected, managing of information collected, processing of information collected and/or providing other services, individually or collectively, for the benefit of a user. Each software application may include a number of features, with many features (e.g., user authentication features) shared between multiple software applications. Other features may be supported only by one associated software application or a defined subset of software applications. A given multi-layer service-oriented platform could support hundreds of software applications and hundreds of thousands of features. Those applications and features could be supported by thousands of services and microservices that exist in vast and ever-changing interdependent layers.

Software development teams may release code updates that change various software services, launch new software services, change existing features of existing software applications, add new software applications, add new software application features to existing software applications, and/or the like. Non-limiting example of applications and/or tools that may be included in a multi-layer service-oriented platform, include Jira Software® by Atlassian, Inc. Jira Service Management® by Atlassian Inc., Confluence® by Atlassian, Inc., Loom® video messaging, and Trello®.

The term “internal resource” refers to a software program, application, platform, or service that is configured by an organization (e.g., an enterprise owner of a multi-layer service-oriented platform) to provide functionality to another one or more of the software programs, applications, platforms, or services operating on a multi-layer service-oriented platform, either directly or indirectly, through one or more other services. Internal resources operate on a compiled code base and/or use data repositories that are at least partially shared by other software programs, applications, or services of the multi-layer service-oriented platform. In some embodiments, application code bases, service code bases, and code bases that support an internal resource are hosted on common servers or using computing devices operating within a common intranet or network.

The term “external resource” refers to a software program, application, platform, or service that is configured to communicate with applications, services, software programs, and/or devices of a multi-layer service-oriented platform but which operates on a compiled code base that is separate from code bases of the multi-layer service-oriented platform. In some embodiments, communications between an external resource and an application or service calling the external resource takes place through a firewall and/or other network security features of the multi-layer service-oriented platform. The external resource operates on a compiled code base or repository that is separate and distinct from that which supports the application or service of the multi-layer service-oriented platform calling the external resource. The external resource is generally considered outside of the ecosystem of internal resources that are generated, operated, maintained, and controlled by developers of the multi-layer service oriented platform.

The term “issue tracking system” refers to a software application that can be used to manage a wide range of tasks and/or projects. For instance, an issue tracking system may find particular application in managing a service desk of an organization's information technology function. In this regard, an issue tracking system may allow the organization to design, plan, deliver, operate, and/or control the services that it offers to clients. An example of an issue tracking system is Jira by Atlassian, Inc. In some embodiments, the issue tracking system is a software application of a plurality of software application, tools, features, services, microservices, and/or the like associated with a multi-layer service-oriented platform.

The term “issue document” refers to a digital object storing information that includes data, formats, and instructions describing a work item or a group of work items. In some embodiments, the work item is a software feature development task. An issue document may include information such as a user-generated description of a software feature development task, issue document status (e.g., closed, open, awaiting review), user assignment, issue document urgency, issue document age, and/or the like. The information in an issue document may take the form of textual data, images, audio data, video data, and/or other representation of information that describes a work item. An issue document may be generated by an issue tracking system such as Jira Software® by Atlassian, Inc. and may be stored in a data store as files, data structures, or the like.

In some embodiments, the issue document includes information arranged in a particular format or schema based on the issue tracking system and/or particular configuration of the issue tracking system. For example, the issue document may include a title field comprising information that describes a title and/or other identification for the issue document, summary field comprising a summary of the software feature development task defined by the issue document, a description field comprising a description of a software feature development task defined by the issue document, issue type field comprising information that describes the issue type of the issue document (e.g., epic, user stories, or the like), related product field comprising information that describes related software features, related software applications, related tools, and/or the like, technical information field comprising technical information associated with the software feature development task defined by the issue document, and/or other fields. In some embodiments, one or more fields of an issue document may include links (e.g., hyperlinks or the like) to other features, tools, software applications, and/or external resources. In addition to the information describing the work item, an issue document may be associated with metadata such as issue document type (e.g., parent issue document, child issue document, or the like), issue document creator, issue document creation time, issue document access details (e.g., time(s) of issue document access and/or identifiers of accessing users), issue document permissions (e.g., whether individual users, user types, user groups or the like can read and/or edit the issue document), issue document status, or the like.

In some embodiments, one or more child issue documents comprising software feature development sub-tasks may be generated based on the issue document. For example, the issue document may represent a parent issue document of the one or more child issue documents generated in accordance with techniques described herein. An issue document may be input to a machine learning model, such as a large language model, along with context data for the issue document to generate candidate software feature development sub-tasks for the issue document. In some embodiments, the issue document (or a portion thereof) may form a portion of context data input to a machine learning model, such as a large language model, to generate candidate software feature development sub-tasks for the issue document.

The term “software feature development task” refers to a work item such as features, user requirements, software bugs, and other items that represent work. For example, an issue document may capture epics, user stories, or other tasks. The term “epic” as used herein refers to a larger body of work such as a collection of work items. The term “story” as used herein refers to requirements, such as software requirements, expressed from the perspective of the user. As another example, an issue document may capture information related to unintended behaviors of a given software product (which may be referred to as a “bug”). A software feature development task may be segmented or otherwise decomposed into smaller units of work (e.g., software feature development sub-tasks) in accordance with one or more techniques of the present disclosure.

The term “software feature development sub-task” refers to a smaller unit of work associated with an issue document (e.g., relative to the software feature development task defined by the issue document). For example, a software feature development sub-task may represent a more granular decomposition of the work required to complete a software feature development task defined by the issue document. In some embodiments, one or more software feature development sub-tasks is selected for an issue document from one or more candidate software feature development sub-tasks.

The term “candidate software feature development sub-task” refers to a software feature development task prediction generated by a large language model that has been trained on a corpus of issue documents and software feature development tasks and sub-tasks. A candidate software feature development sub-task, for example, may be associated with a likelihood of being a software feature development task for the issue document, where the likelihood satisfies a threshold. For example, a candidate software feature development sub-tasks may be associated with a prediction score that satisfies a prediction score threshold corresponding to the likelihood of being a candidate software feature development sub-task for the issue document.

A candidate software feature development sub-task may be presented to a user as a potential software feature development sub-task. For example, one or more candidate software feature development sub-tasks may be generated by a large language model and presented to a user for selection or for user input regarding the candidate software feature development sub-tasks. For example, a candidate software feature development sub-task may be selected and/or refined based on user input. In some embodiments, a candidate software feature development sub-task is generated by inputting a generative model prompt and/or context data to the large language model. Non-limiting examples of a generative model prompt include “suggest child issues from information in this issue,” “suggest user stories from information in this issue,” or the like. In some embodiments, the generative model prompt is a few-shot prompt. For instance, using one or more techniques of the present disclosure, a few-shot prompt may be generated for an issue document. The generative model prompt, which may be few-shot prompt, may be generated based on the issue document and/or context data. For example, the generative model prompt may include at least a portion of the issue document (e.g., summary, description, and/or the like) and context data for the issue document. The candidate software feature development sub-task(s) generated by the large language model may be generated in the context of the issue document based on the context data associated with the issue document and presented to a user as predicted software feature development task for the particular software development task defined by the issue document (e.g., included in the issue document).

The term “child issue document” refers to a digital object storing information that describes a software feature development sub-task of one or more software feature development sub-tasks generated for an issue document. A child issue document may include information such as a description of the software feature development sub-task, child issue document status (e.g., closed, open, awaiting review), user assignment, child issue document urgency, child issue document age, and/or the like. The information in a child issue document may take the form of textual data, images, audio data, video data, and/or other representation of information that describes a work item. The child issue document may be stored in a data store as files, data structures, or the like.

In some embodiments, the child issue document includes information arranged in a particular format or schema based on the issue tracking system and/or particular configuration of the issue tracking system. For example, the child issue document may include a title field comprising information that describes a title and/or other identification for the child issue document, summary field comprising a summary of the software feature development sub-task defined by the child issue document, a description field comprising a description of the software feature development sub-task defined by the issue document, issue type field comprising information that describes the issue type of the child issue document, custom field comprising text that the user has configured to be added to the issue document, related product field comprising information that describes related software features, related software applications, related tools, and/or the like, technical information field comprising technical information associated with the software feature development sub-task defined by the issue document, and/or other fields. In some embodiments, one or more fields of a child issue document may include links (e.g., hyperlinks, attachments, or the like) to other features, tools, software applications, and/or external resources. In addition to the information describing the work item, a child issue document may be associated with metadata such as issue document type, a child issue document creator, child issue document creation time, child issue document access details (e.g., time(s) of child issue document access and/or identifiers of accessing users), child issue document permissions (e.g., whether individual users, user types, user groups or the like can read and/or edit the child issue document), child issue document status, or the like.

The term “large language model” refers to a data entity, algorithm, or set of algorithms that lend themselves to text or language prediction, suggestion, or generation and are trained on vast data sets (e.g., terabytes of text data that could include billions of words). Large language models can include hundreds of billions of parameters or hyper-parameters. Large language models typically consist of a set of neural networks (e.g., a transformer neural network architecture) that is trained to generate a predictive text output (e.g., natural language text) in response to an input. In some embodiments, the input comprises an issue document and/or context data.

In some embodiments, the large language model maybe trained to generate a predictive output (e.g., natural language text) in response to a textual prompt, such as a generative model prompt, as described herein. For example, a large language model may include a generative machine learning model such as a generative pre-trained transformer (GPT) model configured to generate a predictive output comprising candidate software feature development sub-tasks for an issue document. In some embodiments, the large language model may be trained to generate a predictive output (e.g., natural language text) in response to a textual prompt, an issue document, and context data.

The term “AI agent” refers to a computer-implemented process executed by appropriately configured circuitry for obtaining and providing a generative model prompt and/or context data to a large language model. For example, the AI agent may be configured to identify, extract, and or aggregate context data for an issue document from one or more context data sources and provide a generative model prompt along with the context data to the large language model. In some embodiments, the AI agent may be configured to provide the context data to the large language model via the generative model prompt.

The term “task segmentation request” refers to signal, data, message (e.g., an inter-service message, intra-service message, network message, etc.), and/or computer readable instructions descriptive of a request to generate a predictive output comprising software feature development sub-tasks for an issue document. For example, task segmentation request associated with an issue document may be indicative of a request to generate software feature development sub-tasks for the issue document.

The term “domain-specific entity relation graph” refers to a data structure configured to represent relationships (e.g., dependency relationships, or the like) between entities (e.g., software applications, features, services, microservices, repositories, or the like) of a multi-layer service-oriented platform. For example, a domain-specific entity relation graph may comprise entity data objects and entity relationship objects that represent networks of communication, data organization, computing devices, data exchanged, the like, or combinations thereof for a plurality of entities of a multi-layer service-oriented platform. In some embodiments, entity data objects are represented by nodes of the domain-specific entity relation graph. In some embodiments, entity relationship objects are represented by edges of the domain-specific entity relation graph. In some embodiments, a graphical representation of the domain-specific entity relation graph can be, at least partially, rendered via a graphical user interface. The domain-specific entity relation graph may comprise one or more weighted graphs, multigraphs, isomorphic graphs, trees, the like, or combinations thereof. The term “entity data object” as used herein refers to a data structure corresponding to and/or associated with an entity. For example, an entity data object may comprise information about software applications, features, services, microservices, repositories, and/or other entities associated with a multi-layer service-oriented platform.

The term “entity relationship object” refers to a data structure representing a relationship between entities of a multi-layer service-oriented platform. For example, one or more entities may rely on functionalities provided by other entities or otherwise linked to other entities. For example, an application may receive encrypted data from a first service, or application, and in order for the application to read the encrypted data it needs to be authenticated by a second service, which upon authentication provides an encryption key to read the encrypted data. In such an example, the entity relationship object can be configured to represent a relationship between the first service, or application, and the second service. For example, the entity relationship object may identify that an authentication process relationship requires the exchange of encrypted data.

The term “issue document identifier” refers to one or more items or elements by which an issue document may be uniquely identified from other issue documents. An issue document identifier may be in the form of text string(s), numerical character(s), alphabetical character(s), alphanumeric code(s), American Standard Code for information Interchange (ASCII) characters(s), and/or the like.

The term “user identifier” refers to one or more items or elements by which a user may be uniquely identified from other users. For instance, a user identifier may be configured to uniquely identify a user of a task segmentation system and/or an issue tracking system as described herein. A user identifier may be in the form of text string(s), numerical character(s), alphabetical character(s), alphanumeric code(s), American Standard Code for information Interchange (ASCII) characters(s), and/or the like.

The terms “input,” “indication,” “indication input,” “interaction,” “interaction input,” or the like refer to an identifiable, non-transitory occurrence that has technical significance for system hardware and/or software. In some embodiments, an interaction input may be user-generated via at least a user interface associated with a computing device, such as keystrokes, mouse movements, voice commands, and/or the like. In some embodiments, an interaction input may be application-generated (i.e., automatically and/or dynamically internally generated by an application via at least computing circuitry), such as program loading, compiling a data object, errors, and/or the like. For example, an application function may be caused by, and/or a data object may be generated in response to, a user interface interaction input and/or an internal confirmation interaction input generated by the application or associated computing device(s).

The terms “machine learning module,” “machine learning model,” “ML module(s),” or “ML model(s)” refer to a machine learning or deep learning task or mechanism. The term “machine learning” refers to a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, a large language model as defined above, or the like.

A machine learning model may be initially fit or trained on a training dataset (e.g., a set of examples used to fit the parameters of the model). The model may be trained on the training dataset using supervised or unsupervised learning. The model may be run with the training dataset and produce a result, which is then compared with a target, for each input vector in the training dataset. Based on the result of the comparison and the specific learning algorithm being used, the parameters of the model may be adjusted.

The machine learning models as described herein may make use of multiple ML engines (e.g., for analysis, transformation, and other needs). The system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models may be some form of neural network. The underlying ML models may be learning models (supervised or unsupervised). As examples, such algorithms may be prediction (e.g., linear regression) algorithms, classification (e.g., decision trees) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

The ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders, generative pre-trained transformer (GPT) model, or the like).

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein. The ML models herein may undergo a second or multiple subsequent training phases for retraining the models. In various embodiments, the ML model includes a pre-trained LLM. In various embodiments, the pre-trained LLM is leveraged to generate candidate software feature development sub-tasks, select software feature development feature sub-tasks from candidate software feature development sub-tasks, refine candidate software feature development sub-tasks, and generate child issue documents.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The phrases “in one embodiment,” “according to one embodiment,” and the like generally mean that the particular feature, structure, or characteristic following the phrase may be included in the at least one embodiment of the present invention and may be included in more than one embodiment of the present invention (importantly, such phrases do not necessarily refer to the same embodiment).

The terms “about,” “approximately,” or the like, when used with a number, may mean that specific number, or alternatively, a range in proximity to the specific number, as understood by persons of skill in the art field.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The term “plurality” refers to two or more items.

The term “set” refers to a collection of one or more items.

The term “or” is used herein in both the alternative and conjunctive sense, unless otherwise indicated.

Thus, use of any such terms, as defined herein, should not be taken to limit the spirit and scope of embodiments of the present disclosure.

### Example System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

Methods, apparatuses, and computer program products of the present disclosure may be embodied by any of a variety of devices. For example, the method, apparatus, and computer program product of an example embodiment may be embodied by a networked device (e.g., a multi-layer service-oriented platform, or the like), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

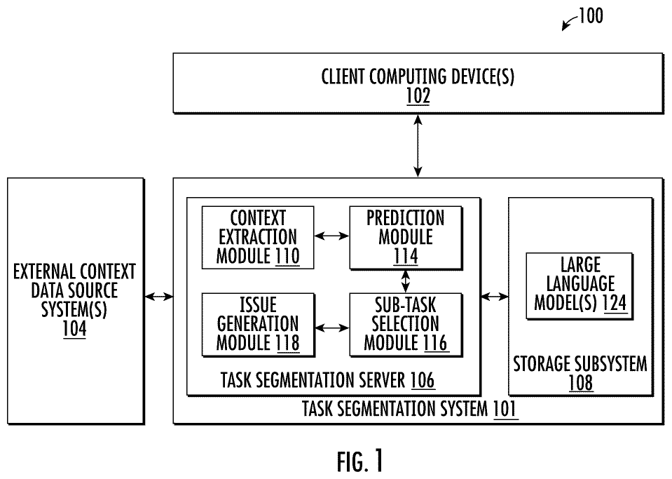

In this regard, FIG. 1 shows an example task segmentation system architecture 100 within which embodiments of the present disclosure may operate. The depiction of the example task segmentation system architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the task segmentation system architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, and/or add aspects and/or components.

As shown in FIG. 1, the task segmentation system architecture 100 includes a task segmentation system 101, one or more client computing devices 102, and one or more external context data source systems 104. The task segmentation system 101 may be configured to receive requests, such as a task segmentation request associated with an issue document, from client computing devices 102, process the request to generate predictive outputs comprising software feature development sub-tasks, and provide the predictive outputs to the client computing devices 102. The example task segmentation system architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate candidate software feature development sub-tasks for an issue document, refined software feature development sub-tasks, and/or the like. In some embodiments, the one or more machine learning models include a large language model (LLM) configured to generate candidate software feature development sub-tasks for an issue document based on the issue document and/or context data associated with the input document. One or more candidate software feature development sub-tasks may be refined and/or selected based on the generated candidate software feature development sub-tasks.

In some embodiments, the functions of one or more of the illustrated components in FIG. 1 may be performed by a single computing device or by multiple computing devices, which devices may be local or cloud based. It will be appreciated that the various functions performed by the task segmentation system 101, the one or more client computing devices 102, and/or the one or more external context data source systems 104 may be embodied by a single apparatus, subsystem, or system comprising one or more sets of computing hardware (e.g., processor(s) and memory) configured to perform the various functions thereof. For example, in some embodiments, one or more of the components of the task segmentation system 101 and/or one or more external context data source systems 104 may be embodied by a multi-layer service-oriented platform. Alternatively or additionally, in some embodiments, one or more of the components of the task segmentation system 101 and/or one or more external context data source systems 104 may be embodied by a client computing device 102.

In the depicted embodiment, as shown in FIG. 1, the task segmentation system 101 includes a task segmentation server 106 and a storage subsystem 108. The storage subsystem 108 may be configured to store input data, training data, and/or the like that may be used by the task segmentation system 101 to perform predictive data analysis and/or training operations of the present disclosure. In addition, the storage subsystems may be configured to store model definition data used by the task segmentation system 101 to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FcRAM, NVRAM, MRAM, RRAM, SONOS, FJG RAM, Millipede memory, racetrack memory, and/or the like. Additionally, the storage subsystem 108 may be configured to store one or more machine learning models, including one or more large language models 124.

The task segmentation server 106 may be configured to perform various functionalities of the task segmentation system 101 including, but not limited to, receiving task segmentation requests, identifying context data sources, aggregating context data, generating candidate software feature development sub-tasks, receiving candidate software feature development sub-task selections, selecting software feature development sub-tasks, refining software feature development sub-tasks, generating child issue documents, causing rendering of candidate software feature development sub-tasks to a display of client computing devices 102, causing rendering of selected and/or refined candidate software feature development sub-tasks to a display of client computing devices, and/or causing rendering of child issue documents to a display of client computing devices 102.

In the depicted embodiment, as shown in FIG. 1, the task segmentation server 106 includes a context extraction module 110, a prediction module 114, a sub-task selection module 116, and/or an issue generation module 118. Each of the context extraction module 110, prediction module 114, sub-task selection module 116, and/or an issue generation module 118 may be any means such as a device or circuitry embodied in either hardware, software, or a combination of hardware and software configured to facilitate and/or perform one or more functionalities associated with generating software feature development sub-tasks for an issue document.

The context extraction module 110 may comprise one or more computing devices embodied in hardware, software, firmware and/or a combination thereof configured to facilitate and/or perform various functionalities associated with automatically and intelligently generating software feature development sub-tasks for an issue document as described herein, including receiving and/or transmitting, one or more datasets, objects, instructions, and/or the like from and/or to one or more external context data source systems 104 and/or other modules (e.g., prediction module 114, sub-task selection module 116, and/or issue generation module 118). In some embodiments, the datasets, objects, and/or the like received and/or transmitted by the context extraction module 110 may be provided as input to a large language model 124 and/or other machine learning models to generate candidate software feature development sub-tasks.

In some embodiments, the context extraction module 110 is configured to identify one or more context data sources for an issue document and aggregate context data for the issue document based on the one or more context data sources. For example, the context extraction module may extract context data for an issue document from one or more context data sources and aggregate the extracted context data. In some embodiments, aggregating the context data may include performing one or more preprocessing operations such as, but not limited to, deduplication (e.g., removing duplicate context data extracted from context data sources), data transformation (e.g., structuring unstructured context data, scaling, normalizing, and/or standardizing context data), dimensionality reduction (e.g., reducing the size of the context data extracted from the context data sources into low-dimensional space, or the like), and/or feature engineering (e.g., organizing the context data extracted from the context data sources, extracting relevant features, or the like). The one or more preprocessing operations may include transforming one or more portions of the context data extracted from the context data sources into formats, types, or other domains compatible with downstream models, such as the large language model 124.

In some embodiments, a context data source may be supported by or associated with an external context data source system 104. In such embodiments, aggregating context data for an issue document may include accessing an external context data source system 104 to extract context data from the context data source supported by the external context data source system 104. In some embodiments, a machine learning model is leveraged to identify context data sources associated with an issue document, extract the context data from the context data sources, and/or aggregate the extracted context data. In some embodiments, the context extraction module 110 is configured to extract at least a portion of the context data for the issue document from the issue document itself and or related issue documents such as parent issue documents and/or child issue documents associated with the issue document. In this regard, in such embodiments, the extracted context data may be referred to as source issue context data and the issue document may be referred to as an internal context data source.

In some embodiments, the context extraction module 110 is configured to identify the context data for an issue document based on certain information in the issue document. For example, the issue document may include attachments, hyperlinks corresponding to context data sources such as features (e.g., content pages, chat platforms, visual media objects, or the like) provided by one or more other software applications of a multi-layer service-oriented platform associated with the software application hosting the issue document, and/or the like. For example, in some embodiments, the software application hosting the issue document, or otherwise supporting the issue document, may be integrated with one or more other software applications supported by the multi-layer service-oriented platform. The context extraction module 110 may be configured to provide the context data aggregated for an issue document to the prediction module 114.

The prediction module 114 may comprise one or more computing devices embodied in hardware, software, firmware and/or a combination thereof configured to facilitate and/or perform various functionalities associated with automatically and intelligently generating software feature development sub-tasks for an issue document as described herein, including receiving and/or transmitting, one or more datasets, objects, instructions, and/or the like from and/or to one or more other modules (e.g., context extraction module 110, sub-task selection module 116, and/or issue generation module 118).

In some embodiments, the prediction module 114 is configured to receive context data for an issue document from the context extraction module 110 and generate candidate software feature development sub-tasks for the issue document based on the issue document and/or the context data. In some embodiments, the prediction module 114 leverages the large language model 124 to generate the candidate software feature development sub-tasks. For example, the prediction module 114 may be configured to provide the issue document and/or context data to a large language model 124 configured to output candidate software feature development sub-tasks in response to receiving the issue document and/or context data. In some embodiments, the prediction module 114 may be configured to generate and provide a generative model prompt to the large language model along with the context data. For example, the generative model prompt may be a few-shot prompt that includes the context data. In some embodiments, the context data includes the issue document or a portion thereof. In some embodiments, generating the generative model prompt may include receiving user input and constructing the generative model prompt based on the user input. In some embodiments, the prediction module 114 is configured to provide the candidate software feature development sub-tasks to the sub-task selection module 116.

The sub-task selection module 116 may comprise one or more computing devices embodied in hardware, software, firmware and/or a combination thereof configured to facilitate and/or perform various functionalities associated with automatically and intelligently generating software feature development sub-tasks for an issue document as described herein, including receiving and/or transmitting, one or more datasets, objects, instructions, and/or the like from and/or to one or more other modules (e.g., context extraction module 110, prediction module 114, and/or issue generation module 118).

In some embodiments, the sub-task selection module 116 is configured to receive, from the prediction module 114, the candidate software feature development sub-tasks (e.g., generated using a large language model 124). In some embodiments, the sub-task selection module 116 is configured to receive an indication of a candidate software feature development sub-task selection and select one or more software feature development sub-tasks from the one or more candidate software feature development sub-tasks in response to receiving the indication of the candidate software feature development sub-task selection. In some embodiments, the sub-task selection module 116 is configured to refine the one or more software feature development sub-tasks selected to generate one or more refined software feature development sub-tasks.

The issue generation module 118 may comprise one or more computing devices embodied in hardware, software, firmware and/or a combination thereof configured to facilitate and/or perform various functionalities associated with automatically and intelligently generating software feature development sub-tasks for an issue document as described herein, including receiving and/or transmitting, one or more datasets, objects, instructions, and/or the like from and/or to one or more other modules (e.g., context extraction module 110, prediction module 114, and/or sub-task selection module 116).

In some embodiments, the issue generation module is configured to generate one or more child issue documents corresponding to the one or more software feature development sub-tasks that is selected and/or refined at the sub-task selection module 116. For example, each child issue document may include a software feature development sub-task selected and/or refined from the one or more candidate software feature development sub-tasks generated by the large language model 124 at the prediction module 114.

Two or more of the components illustrated in the task segmentation system 101 and the task segmentation system architecture 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In some embodiments, the components depicted in FIG. 1 as being included in the task segmentation system 101, although not required to be an integral system, may be connected via one or more networks. In some embodiments, one or more APIs may be leveraged to communicate with and/or facilitate communication between one or more of the components illustrated in the task segmentation system 101 and/or task segmentation system architecture 100.

### Example Apparatuses of the Disclosure

Having discussed example systems in accordance with the present disclosure, example apparatuses in accordance with the present disclosure will now be described.

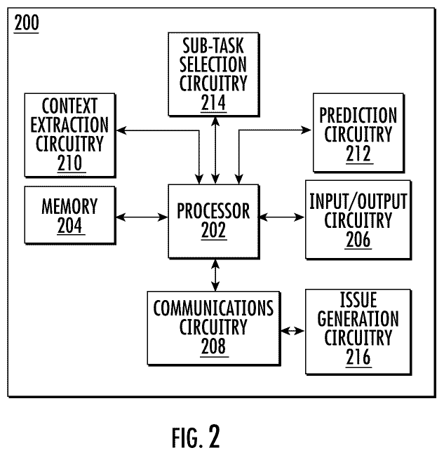

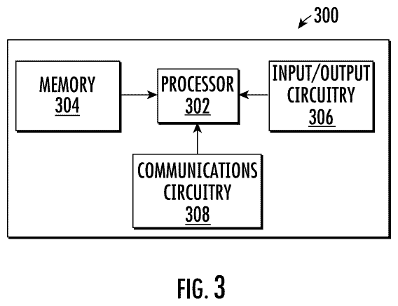

FIG. 2 illustrates a block diagram of a task segmentation apparatus 200 in accordance with some example embodiments. For example, in some embodiments, task segmentation system 101 (or one or more portions thereof), if embodied in a particular embodiment, may be embodied by one or more apparatuses 200. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the functionality of the task segmentation system 101 or any subset thereof may be performed by a single apparatus 200 or multiple apparatuses 200. In some embodiments, the apparatus 200 may comprise one or a plurality of physical devices.

The apparatus 200 may include processor 202, memory 204, input/output circuitry 206, communications circuitry 208, context extraction circuitry 210, prediction circuitry 212, and/or sub-task selection circuitry 214. The apparatus 200 may be configured to execute the operations described herein. Although these components 202-214 are described with respect to functional limitations, it should be understood that the particular implementations necessarily include the use of particular hardware. It should also be understood that certain of these components 202-214 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

In some embodiments, the apparatus 200 includes a context extraction circuitry 210. The context extraction circuitry 210 may include hardware components, software components, and/or a combination thereof configured to, with the processor 202, memory 204, input/output circuitry 206 and/or communications circuitry 208, perform one or more functions associated with a context extraction module 110 (as described above with reference to FIG. 1). In some embodiments, the context extraction circuitry 210 may be configured to receive and/or transmit data, objects, and/or the like from and/or to one or more components of the apparatus 200, through, for example, the use of applications or APIs executed using a processor, such as the processor 202. It should also be appreciated that, in some embodiments, the context extraction circuitry 210 may include a separate processor, specially configured field programmable gate array (FPGA), or application specific interface circuit (ASIC) to provide or otherwise facilitate access to such data, objects, and/or the like used by one or more other components of the apparatus 200. The context extraction circuitry 210 may also provide for communication with other components of the apparatus, system and/or external systems via a network interface provided by the communications circuitry 208.

In some embodiments, the apparatus 200 includes a prediction circuitry 212. The prediction circuitry 212 may include hardware components, software components, and/or a combination thereof configured to, with the processor 202, memory 204, input/output circuitry 206 and/or communications circuitry 208, perform one or more functions associated with a prediction module 114 (as described above with reference to FIG. 1). In some embodiments, the prediction circuitry 212 may be configured to receive and/or transmit data, objects, and/or the like from and/or to one or more components of the apparatus 200, through, for example, the use of applications or APIs executed using a processor, such as the processor 202. It should also be appreciated that, in some embodiments, the prediction circuitry 212 may include a separate processor, specially configured field programmable gate array (FPGA), or application specific interface circuit (ASIC) to provide or otherwise facilitate access to such data, objects, and/or the like used by one or more other components of the apparatus 200. The prediction circuitry 212 may also provide for communication with other components of the apparatus, system and/or external systems via a network interface provided by the communications circuitry 208.

In some embodiments, the apparatus 200 includes a sub-task selection circuitry 214. The sub-task selection circuitry 214 may include hardware components, software components, and/or a combination thereof configured to, with the processor 202, memory 204, input/output circuitry 206 and/or communications circuitry 208, perform one or more functions associated with a sub-task selection module 116 (as described above with reference to FIG. 1). In some embodiments, the sub-task selection circuitry 214 may be configured to receive and/or transmit data, objects, and/or the like from and/or to one or more components of the apparatus 200, through, for example, the use of applications or APIs executed using a processor, such as the processor 202. It should also be appreciated that, in some embodiments, the sub-task selection circuitry 214 may include a separate processor, specially configured field programmable gate array (FPGA), or application specific interface circuit (ASIC) to provide or otherwise facilitate access to such data, objects, and/or the like used by one or more other components of the apparatus 200. The sub-task selection circuitry 214 may also provide for communication with other components of the apparatus, system and/or external systems via a network interface provided by the communications circuitry 208.

In some embodiments, the apparatus 200 includes an issue generation circuitry 216. The issue generation circuitry 216 may include hardware components, software components, and/or a combination thereof configured to, with the processor 202, memory 204, input/output circuitry 206 and/or communications circuitry 208, perform one or more functions associated with an issue generation module 118 (as described above with reference to FIG. 1). In some embodiments, the issue generation circuitry 216 may be configured to receive and/or transmit data, objects, and/or the like from and/or to one or more components of the apparatus 200, through, for example, the use of applications or APIs executed using a processor, such as the processor 202. It should also be appreciated that, in some embodiments, the issue generation circuitry 216 may include a separate processor, specially configured field programmable gate array (FPGA), or application specific interface circuit (ASIC) to provide or otherwise facilitate access to such data, objects, and/or the like used by one or more other components of the apparatus 200. The issue generation circuitry 216 may also provide for communication with other components of the apparatus, system and/or external systems via a network interface provided by the communications circuitry 208.

Additionally or alternatively, in some embodiments, two or more of the sets of circuitries embodying processor 202, memory 204, input/output circuitry 206, communications circuitry 208, context extraction circuitry 210, prediction circuitry 212, sub-task selection circuitry 214, and/or issue generation circuitry 216 are combinable. Alternatively or additionally, in some embodiments, one or more of the sets of circuitry perform some or all of the functionality described associated with another component. For example, in some embodiments, two or more of the sets of circuitry embodied by processor 202, memory 204, input/output circuitry 206, and communications circuitry 208, context extraction circuitry 210, prediction circuitry 212, and/or sub-task selection circuitry 214 are combined into a single module embodied in hardware, software, firmware, and/or a combination thereof. Similarly, in some embodiments, one or more of the sets of circuitry, for example, context extraction circuitry 210, prediction circuitry 212, sub-task selection circuitry 214, and/or issue generation circuitry 216 is/are combined with the processor 202, such that the processor 202 performs one or more of the operations described above with respect to each of these sets of circuitry embodied by context extraction circuitry 210, prediction circuitry 212, sub-task selection circuitry 214, and/or issue generation circuitry 216.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Client Computing Device

Referring now to FIG. 3, a client computing device may be embodied by one or more computing systems, such as apparatus 300 shown in FIG. 3. The apparatus 300 may include processor 302, memory 304, input/output circuitry 306, and a communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present invention.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present invention while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, a kiosk, or the like.

In embodiments in which the apparatus 300 is embodied by a limited interaction device, the input/output circuitry 306 includes a touch screen and does not include, or at least does not operatively engage (i.e., when configured in a tablet mode), other input accessories such as tactile keyboards, track pads, mice, etc. In other embodiments in which the apparatus is embodied by a non-limited interaction device, the input/output circuitry 306 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Example Data Flows, Operations, and User Interfaces

As indicated, some embodiments of the present disclosure make important technical contributions to issue tracking systems and/or techniques. In particular, systems and methods are disclosed herein that implement a specially-configured software feature development task segmentation process for improving issue tracking systems that leverage one or more machine learning models including a large language model. By doing so, software feature development task segmentation techniques described herein may provide an improvement in issue tracking systems that may be practically applied to improve various computing tasks, including work item breakdown (e.g., software feature development task segmentation) and issue tracking and management.

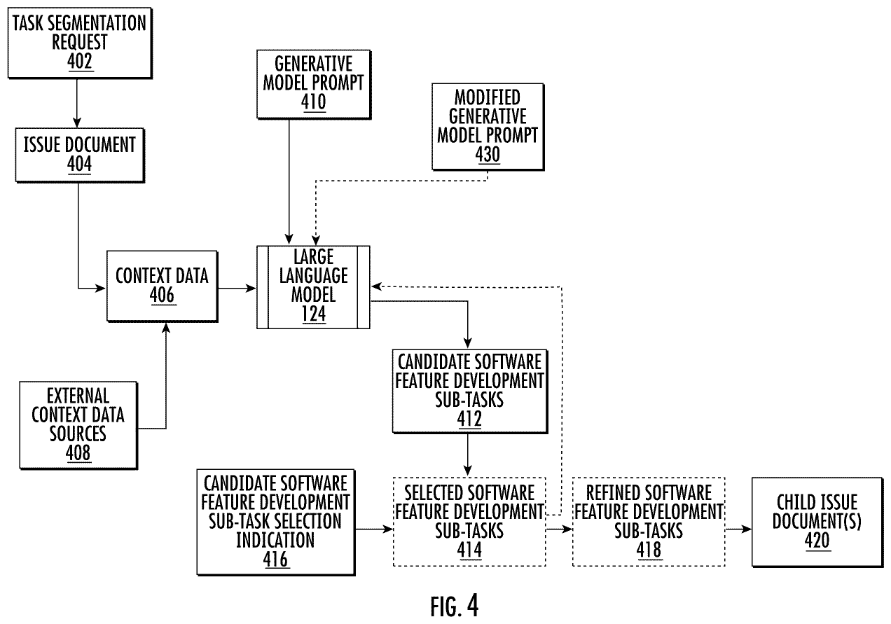

FIG. 4 illustrates a visualization of an example data environment for intelligent and context-aware software feature development task segmentation in accordance with at least some embodiments of the present disclosure. In some embodiments, an issue document 404 is identified or received.

In some embodiments, the issue document 404 is a digital object storing information that describes a work item or a group of work items. In some embodiments, the work item is a software feature development task. The issue document 404 may include information such as a user-generated description of the software feature development task, issue document status (e.g., closed, open, awaiting review), user assignment, issue document urgency, issue document age, and/or the like. The information in the issue document 404 may take the form of textual data, images, audio data, video data, and/or other representation of information that describes a work item.

In some embodiments, a software feature development task is a work item such as features, user requirements, software bugs, and other items that represent work. For example, an issue document may capture epics, user stories, or other tasks. The term “epic” as used herein may refer to a larger body of work such as a collection of work items. The term “story” as used herein may refer to requirements, such as software requirements, expressed from the perspective of the user. As another example, an issue document may capture information related to unintended behaviors of a given software product (which may be referred to as a “bug”).

The issue document 404 may be generated by an issue tracking system such as Jira by Atlassian, Inc. and may be stored in a data store as files, data structures, or the like. In some embodiments, the issue document 404 includes information arranged in a particular format or schema based on the issue tracking system and/or particular configuration of the issue tracking system. For example, the issue document 404 may include a title field comprising information that describes a title and/or other identification for the issue document 404, summary field comprising a summary of the software feature development task defined by the issue document, a description field comprising a description of a software feature development task defined by the issue document, issue type field comprising information that describes the issue type of the issue document (e.g., epic, user stories, or the like), custom field comprising text that the user has configured to be added to the issue document, related product field comprising information that describes related software features, related software applications, related tools, and/or the like, technical information field comprising technical information associated with the software feature development task defined by the issue document 404, and/or other fields. In some embodiments, one or more fields of an issue document may include links (e.g., hyperlinks, attachment, or the like) to other features, tools, software applications, and/or external resources. In addition to the information describing the work item, the issue document 404 may be associated with metadata such as issue document type (e.g., parent issue document, child issue document, or the like), issue document creator, issue document creation time, issue document access details (e.g., time(s) of issue document access and/or identifiers of accessing users), issue document permissions (e.g., whether individual users, user types, user groups or the like can read and/or edit the issue document), issue document status, or the like.

In some embodiments, the issue tracking system is a software application that can be used to manage a wide range of tasks and/or projects. In some examples, an issue tracking system may find particular application in managing a service desk of an organization's information technology function. In this regard, an issue tracking system may allow the organization to design, plan, deliver, operate, and/or control the services that it offers to clients. An example of an issue tracking system is Jira by Atlassian, Inc. In some embodiments, the issue tracking system is a software application of a plurality of software application, tools, features, services, microservices, and/or the like associated with a multi-layer service-oriented platform.

In some embodiments, the multi-layer service-oriented platform is a complex network computing environment associated with a multitude of computing devices, applications, services, and microservices. The multi-layer service-oriented platform, for example, may support an application or multiple applications that are configured for the collection of information (e.g., in the form of application data objects), storing of information collected, managing of information collected, processing of information collected and/or providing other services, individually or collectively, for the benefit of a user. Each software application may include a number of features, with many features (e.g., user authentication features) shared between multiple software applications. Other features may be supported only by one associated software application or a defined subset of software applications. A given multi-layer service-oriented platform could support hundreds of software applications and hundreds of thousands of features. Those applications and features could be supported by thousands of services and microservices that exist in vast and ever-changing interdependent layers. Software development teams may release code updates that change various software services, launch new software services, change existing features of existing software applications, add new software applications, add new features to existing software applications, and/or the like. Non-limiting example of applications and/or tools that may be included in a multi-layer service-oriented platform, include Jira by Atlassian, Inc. Jira Service Management by Atlassian Inc., Confluence by Atlassian, Inc., Loom video messaging, and Trello.

In some embodiments, the issue document 404 is identified in response to receiving a task segmentation request 402. In some embodiments, the task segmentation request 402 is signal, data, message (e.g., an inter-service message, intra-service message, network message, etc.), and/or computer readable instructions descriptive of a request to generate a predictive output comprising software feature development sub-tasks for an issue document. For example, task segmentation request 402 associated with an issue document may be indicative of a request to generate software feature development sub-tasks for the issue document.

In some embodiments, the task segmentation request 402 includes the issue document 404. In some embodiments, the task segmentation request 402 includes an issue document identifier for the issue document. In some embodiments, the issue document identifier is one or more items or elements by which the issue document 404 is uniquely identified from other issue documents. The issue document identifier may be in the form of text string(s), numerical character(s), alphabetical character(s), alphanumeric code(s), American Standard Code for information Interchange (ASCII) characters(s), and/or the like. In this regard, in some embodiments, the issue document 404 may be identified and/or retrieved from a data store based on the corresponding issue document identifier.

In some embodiments, context data 406 associated with the issue document is extracted, aggregated, or otherwise obtained. In some embodiments, at least a portion of the context data 406 is extracted from one or more context data sources including the issue document 404 and/or external context data sources 408. In this regard, one or more context data sources may be identified in response to receiving the task segmentation request 402 and/or identifying the issue document 404.

At least a portion of the context data 406 may include attributes of the issue document 404 such as, but not limited to, a description of the software feature development task defined by the issue document 404, a summary of the software feature development task defined by the issue document, issue type of the issue document 404 (e.g., epic, user stories, or the like), data from customer fields (if any) in the issue document 404, data associated with a parent issue document (if any) of the issue document 404, data associated with one or more child issue document (if any) of the issue document 404, technical information associated with the software feature development task defined by the issue document 404. In this regard, aggregating the context data 406 for the issue document 404 may include extracting at least a portion of the content of the issue document 404, extracting at least a portion of the content of related issue documents (e.g., parent issue documents, child issue documents, or the like), and/or extracting information (e.g., including metadata) about the issue document and/or related issue documents. For example, as described above, the one or more context data sources may include the issue document 404 (e.g., the description field of the issue document, summary field of the issue document, title filed of the issue document, and/or the like) and/or related issue documents (e.g., parent issue document, child issue document(s), or the like).

In some embodiments, aggregating the context data 406 for the issue document may include extracting, from external data sources 408, data associated with the issue document 404. In some embodiments, the external data sources 408 may include features of one or more other software applications of a multi-layered service-oriented platform associated with the software application hosting and/or supporting the issue document 404. For example, the one or more external data sources may include one or more content pages of other software applications associated with the software application hosting and/or supporting the issue document 404 such as, but not limited to, content page(s) of Confluence (e.g., by Atlassian Inc.) that is associated with the issue document 404, content of a Loom video associated with the issue document 404, and/or the like. In some embodiments, the external context data sources 408 may be identified based on the issue document 404. For example, the issue document 404 may include links (e.g., hyperlinks, attachments, or the like) to one or more external data sources 408, such as, but not limited to, link(s) to a content page of Confluence by Atlassian Inc., link(s) to a Loom video associated with the issue document 404 (e.g., associated with a software feature development task in the issue document 404). In example embodiments, where the issue document 404 includes one or more links to one or more content pages of a second software application, aggregating the context data 406 may include accessing the one or more content pages of the software application via the one or more links and parsing the one or more content pages to identify at least a portion of the context data. In example embodiments, where the issue document 404 includes one or more links to a visual media object, such as a Loom video, aggregating the context data 406 may include accessing the visual media object via the one or more links and parsing the visual media object to identify at least a portion of the context data 406.

Alternatively or additionally, the one or more context data sources may include a domain-specific entity relation graph associated with the issue document 404. For example, aggregating the context data may include identifying one or more entities associated with the issue document by traversing the domain-specific entity relation graph, and identifying at least a portion of the context data based on entity data of the one or entities (e.g., data associated with the one or more entities that are linked, directly or indirectly, with the issue document 404). Non-limiting examples of such entities include other issue documents, projects, services, incidents, post incident reviews, alerts, code deployments, code modifications, team members, other software applications, and/or the like that are linked, directly or indirectly, with the issue document 404.

In some embodiments, a portion of the context data 406 and/or context data sources (e.g., external context data sources 408, internal context data sources) may be identified based on user input which may be received via the task segmentation user interface. For example, user input comprising data that describes one or more external context data sources may be received via the task segmentation user interface.

In some embodiments, one or more candidate software feature development sub-tasks 412 are generated, using a large language model 124 and based on the issue document 404 and/or the context data 406 aggregated from the context data sources. For example, the issue document and/or context data may be applied to the large language model 124 to generate one or candidate software feature development sub-tasks 412 for the issue document 404. For example, the issue document and/or context data may be provided to a large language model 124 configured to output candidate software feature development sub-tasks in response to receiving the issue document and/or context data. By way of example, in a Jira (by Atlassian) environment, the candidate software feature development sub-tasks may represent tasks, sub-tasks, issues, stories, bugs or the like. In some embodiments, generating the one or more candidate software feature development sub-tasks 412 using a large language model 124 includes generating a generative model prompt 410 based on the issue document 404 and/or context data 406. In some embodiments, the generative model prompt 410 is a few-shot prompt. In some embodiments, the context data 406 includes the issue document or at least a portion thereof. For example, the one or more candidate software feature development sub-tasks 412 may be generated, using a large language model 124 and based on the context data 406, wherein the context data 406 includes at least a portion of the issue document 404 and/or related issue documents. In some embodiments, the one or more candidate software feature development sub-tasks 412 are generated and/or outputted by the large language model 124 sequentially. For example, the one or more candidate software feature development sub-tasks 412 may be presented to a user (e.g., via a user interface) one by one as they are being generated by the large language model. In this regard, a first candidate software feature development sub-tasks 412 may be presented to a user while the large language model 124 generates additional candidate software feature development sub-tasks 412.

In some embodiments, a candidate software feature development sub-task 412 is a software feature development task prediction generated for an issue document 404 by a machine learning model, such as the large language model 124. A candidate software feature development sub-task 412, for example, may be associated with a likelihood of being a software feature development task for the issue document, where the likelihood satisfies a predetermined threshold. For example, a candidate software feature development sub-task may be associated with a prediction score that satisfies a prediction score threshold corresponding to the likelihood of being a candidate software feature development sub-task for the issue document. A candidate software feature development sub-task 412 may be presented or otherwise recommended to a user as a potential software feature development sub-task.

In some embodiments, the one or more candidate software feature development sub-tasks 412 are generated by inputting a generative model prompt and/or context data to the large language model 124. Non-limiting examples of a generative model prompt include “suggest child issues from information in this issue,” “suggest user stories from information in this issue,” or the like. In some embodiments, the generative model prompt is a few-shot prompt. For instance, using one or more techniques of the present disclosure, a few-shot prompt may be generated for an issue document. The generative model prompt, which may be a few-shot prompt, may be generated based on the issue document 404 and/or context data 406. As described above, in some embodiment, the context data 406 may include the issue document 404 or a portion thereof. In some embodiments, the generative model prompt may include the context data 406, where the context data 406 may include at least a portion of the issue document 404 (e.g., summary, description, and/or the like in the issue document 404) and/or context data extracted from one or more external context data sources 408. In some embodiments, generating the one or more candidate software feature development sub-tasks 412 for the issue document 404 using the large language model 124 includes generating a few-shot model prompt comprising the context data 406, and providing the few-shot model prompt to the large language model. In some embodiments, generating the one or more candidate software feature development sub-tasks 412 for the issue document 404 using the large language model 124 includes generating a few-shot model prompt (that does not include the context data 406), and providing the few-shot model prompt and the context data 406 to the large language model 124.

Accordingly, the one or more candidate software feature development sub-tasks 412 generated by the large language model 124 may be generated in the context of the issue document 404 based on the context data 406 associated with the issue document 404 and presented to a user as predicted software feature development task(s) for the particular software development task defined by the issue document 404.

In some embodiments, the large language model 124 is a data entity that describes parameters, hyper-parameters, and/or defined operations of a rules-based and/or machine learning model (e.g., model including at least one of one or more rule-based layers, one or more layers that depend on trained parameters, coefficients, and/or the like). A large language model may include any type of model configured, trained, and/or the like to generate a predictive output (e.g., natural language text) in response to an input. In some embodiments, the input comprises issue document and/or context data. In some embodiments, the large language model may include any type of model configured, trained, and/or the like to generate a predictive output (e.g., natural language text) in response to a textual prompt, such as a generative model prompt, as described herein. For example, a large language model may include a generative machine learning model such as a generative pre-trained transformer (GPT) model configured to generate a predictive output comprising candidate software feature development sub-tasks for an issue document. Alternatively or additionally, in some embodiments, the large language model is a multimodal large language model.

In some embodiments, one or more software feature development sub-tasks 414 are selected from the one or more candidate software feature development sub-tasks 412. For example, the one or more selected software feature development sub-tasks 414 may comprise some or all of the one or more candidate software feature development sub-tasks 412. In some embodiments, the one or more selected software feature development sub-tasks 414 are selected from the one or more candidate software feature development sub-tasks 412 in response to candidate software feature development sub-task selection indication 416 (e.g., indication of a candidate software feature development sub-task selection). The candidate software feature development sub-task selection indication 416, for example, may originate from user input received via a task segmentation user interface. For example, in some embodiments, the one or more candidate software feature development sub-tasks 412 is provided to a user via a task segmentation user interface and candidate software feature development sub-task selection indication 416 corresponding to the user selection is received via the task segmentation user interface. In some embodiments, the large language model 124 and/or other machine learning models may be leveraged to select the one or more software feature development sub-tasks 414.

In some embodiments, the one or more selected software feature development sub-tasks 414 is refined to generate one or more refined software feature development sub-tasks 418. In some embodiments, the one or more selected software feature development sub-tasks is refined based on user input. For example, the user input and/or a representation of the user input may be applied to the one or more software feature development sub-tasks 414 to generate the one or more refined software feature development sub-tasks 418. Refining a selected software feature development sub-task 414, for example, may comprise editing the selected software feature development sub-task 414 in accordance with a predefined format and/or a user preference. For example, the description of a selected software feature development sub-tasks may be edited or otherwise modified in such that it is in a standard agile format. The user input may be received via the task segmentation user interface. The one or more refined software feature development sub-tasks 418 may describe software feature development sub-tasks that have been modified and/or customized in accordance with the user input. In some embodiments, the large language model 124 and/or other machine learning models may be leveraged to generate the one or more refined software feature development sub-tasks 418.

As described above, in some embodiments, the one or more candidate software feature development sub-tasks 412 may be generated and/or outputted by the large language model 124 sequentially, such that the one or more candidate software feature development sub-tasks 412 is presented to a user (e.g., via the task segmentation user interface) in the order that they are outputted by the large language model and without waiting for the large language model 124 to generate all the one or more candidate software feature development sub-tasks 412. In some embodiments, the one or more selected software feature development sub-tasks 414 may be selected sequentially. For example, one or more techniques of the present disclosure allows for a user to select a candidate software feature development sub-task prior to the large language model 124 outputting the next candidate software feature development sub-task 412. In this regard, a candidate software feature development sub-task selection indication may be received for each candidate software feature development sub-task 412 (or groups of candidate software feature development sub-tasks 412) sequentially. For example, a user may not need to wait for the large language model 124 to output all the candidate software feature development sub-tasks 412 before selecting a candidate software feature development sub-task 412 (e.g., corresponding to a candidate software feature development sub-task selection indication 416). In this regard, a candidate software feature development sub-task 412 may be selected or rejected prior to the large language model 124 outputting the next candidate software feature development sub-task 412.

Alternatively or additionally, in some embodiments, the one or more selected software feature development sub-tasks 414 may be refined sequentially. For example, user input associated with a selected software feature development sub-task 414 may be received sequentially and applied to the corresponding selected software featured development sub-task 414 to generate a refined software featured development sub-tasks 418. In this regard, a user may not need to wait for the large language model 124 to output all the candidate software feature development sub-tasks 412 before providing user input for refining the candidate software feature development sub-tasks. For example, one or more techniques of the present disclosure allows for a user to provide user input for refining a candidate software feature development sub-task prior to the large language model outputting the next candidate software feature development sub-task 412 and/or before a candidate software feature development sub-task selection indication 416 is received for the next candidate software feature development sub-task 412 outputted by the large language model 124. In this regard, a selected software feature development sub-task 414 may be refined prior to the large language model 124 outputting the next candidate software feature development sub-task 412 and/or prior to a candidate software feature development sub-task selection indication 416 being received for the next candidate software feature development sub-task 412 outputted by the large language model 124.

In some embodiments, refining the one or more selected software feature development sub-tasks 414 comprises providing at least a portion of the selected software feature development sub-task(s) 414 to the large language model 124 to re-generate candidate software development sub-task(s). Alternatively or additionally, in some embodiments, refining the one or more selected software feature development sub-tasks 414 may comprise providing a modified generative model prompt 430 to the large language model 124 to re-generate candidate software development sub-tasks. In this regard, refining the one or more selected software feature development sub-tasks 414 may comprise providing one or more of (i) at least a portion of the selected software feature development sub-tasks 414 or (ii) modified generative model prompt 430 to the large language model 124 to re-generate candidate software feature development sub-task (e.g., representing refined software feature development sub-tasks 418).

In some embodiments, one or more child issue documents 420 corresponding to the one or more selected software feature development sub-tasks 414 or refined software feature development sub-tasks 418 is generated. In some embodiments, the one or more child issue documents 420 is generated in response to a child issue generation request. In some embodiments, a user interface comprising child issue documents from the one or more child issue documents 420 is caused to be rendered to a client computing device display in response to indication of a child issue document selection. For example, indication of a child issue document selection may be received, and a user interface may be caused to be rendered, where the user interface may include a child issue document from the one or more child issue documents 420 corresponding to the child issue document selection.

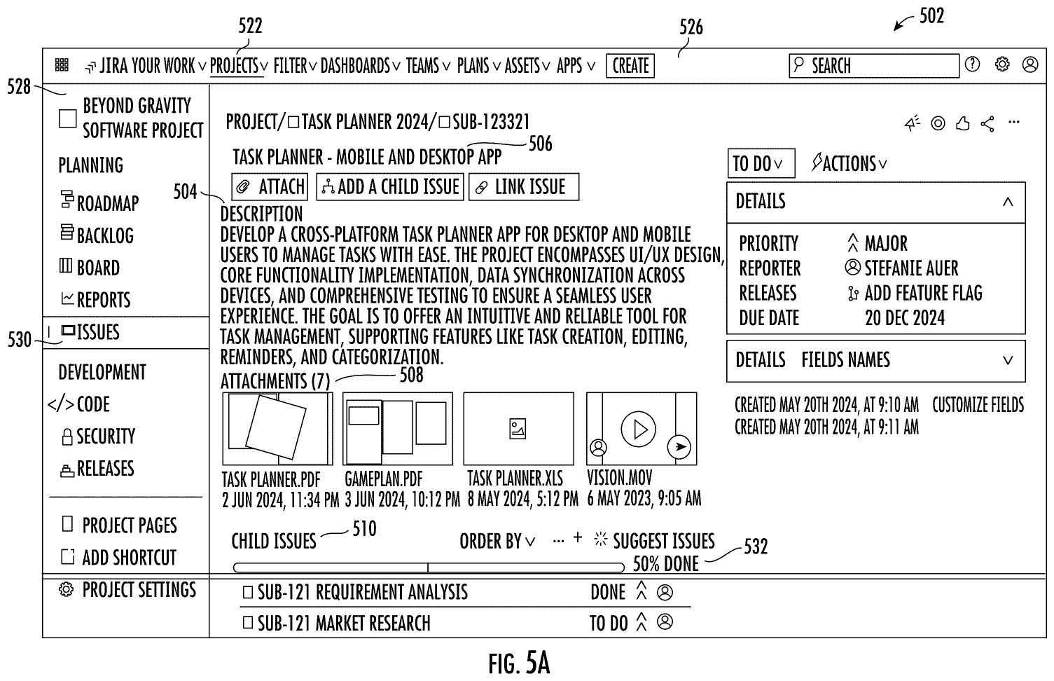

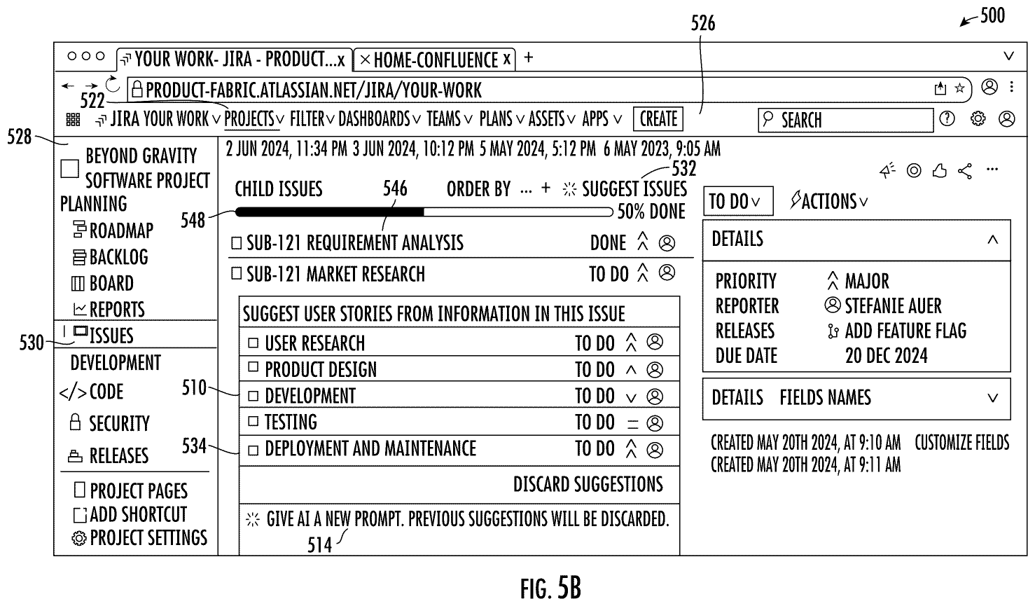

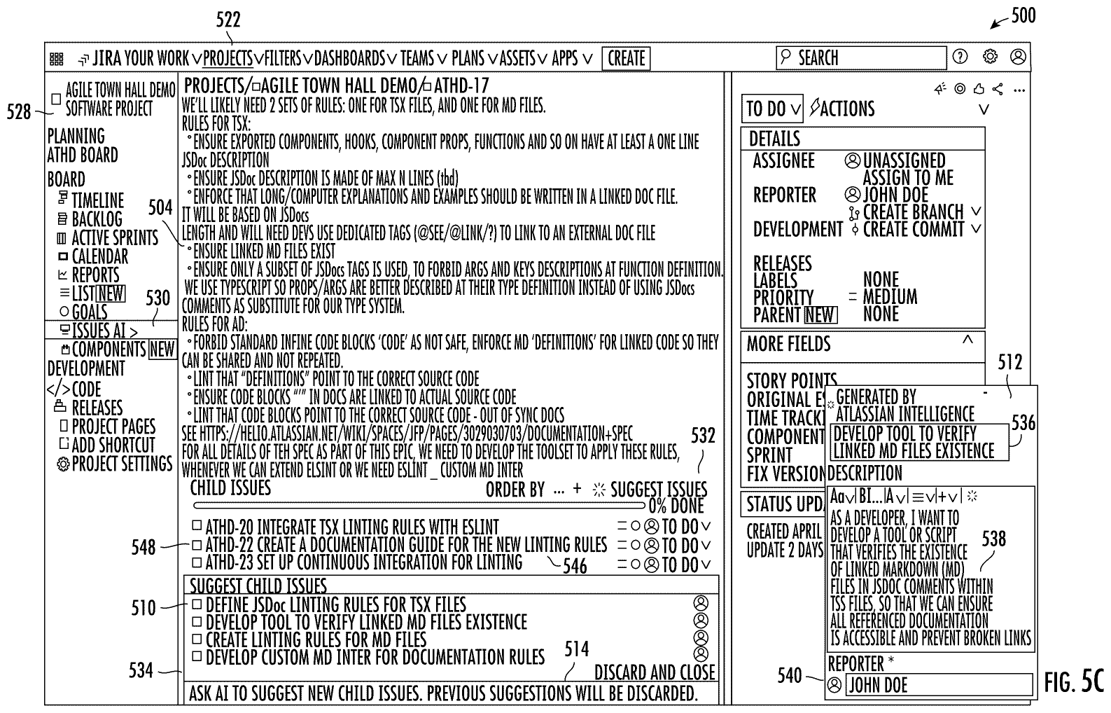

FIGS. 5A-C each depict at least a partial view of example task segmentation user interface 500 configured in accordance with at least some embodiments of the present disclosure. The task segmentation user interface 500 can be, for example, an electronic interface (e.g., graphical user interface) of a client device such as client computing device 102. The task segmentation user interface 500 may include a project user interface element 522 selectable from a menu 526. In the illustrated example task segmentation user interface 500, the menu 526 is positioned at the top of the task segmentation user interface 500. However, it would be appreciated that the menu 526 may be positioned somewhere else within the task segmentation user interface 500. The project user interface element 522 may be configured to facilitate selection of a project. The task segmentation user interface 500 may include a project menu bar 528 comprising one or more user interface elements. In some embodiments, the project menu bar 528 may be rendered on the task segmentation user interface 500 in response to use selection of a project.

The project menu bar 528 of the task segmentation user interface 500 may include an issues user interface element 530. The issues user interface element 522 may be configured to facilitate selection and rendering of an issue document (e.g., visualization of an issue document or portion(s) thereof) on the task segmentation user interface 500. For example, the task segmentation user interface 500 may be configured to display or otherwise provide a visualization of an issue document or at least a portion thereof in response to user interaction with the issues user interface element 530. For example, as shown in FIGS. 5A and 5C, the task segmentation user interface 500 may display a description 504 of the software feature development task defined by the issue document. As further shown in FIG. 5A, the task segmentation user interface 500 may display a title 506 of the issue document. In the illustrated example of FIGS. 5A and 5C, the task segmentation user interface 500 includes one or more links 508 (e.g., hyperlinks, attachments, or the like).

The task segmentation user interface 500 may include a segmentation request user interface element 532 (e.g., “suggest issues”, “suggest child issues”. or the like). The segmentation request user interface element 532 may be configured to facilitate generation of candidate software feature development sub-tasks 510 for the selected issue document. For example, a task segmentation request may be generated for the selected issue document (e.g., rendered on the task segmentation user interface 500) in response to user interaction (e.g., click, select, or the like) with the segmentation request user interface element. In some embodiments, the task segmentation user interface 500 may include a status view configured to display text that indicates a current operation being performed by the large language model (e.g., removing duplicate candidate software feature development sub-tasks, outputting candidate software feature development sub-tasks, and/or the like) and/or a current operation being performed by the system 101. By way of example, where the context data includes child issue documents, the large language model and/or the system 101 may be configured to remove duplicate candidate software feature development sub-tasks that are similar (e.g., semantically similar, or the like) to the child issue document (e.g., description thereof or the like). In this regard, as shown in FIG. 5C, in some embodiments, the task segmentation user interface 500 may be configured to display a child issue view 548. The child issue view 548 may be configured to provide a visualization of child issue documents 546 (or portion thereof) associated with the issue document.

As shown in FIGS. 5A and 5B, the example task segmentation user interface 500 may be configured for presenting a visualization of the candidate software feature development sub-tasks 510 to a user. For example, the task segmentation user interface 500 may provide a candidate sub-task view 534 configured to display output of the large language model (e.g., candidate software feature development sub-tasks 510). In some embodiments, the candidate sub-task view 534 may be configured to display a visualization of a candidate software feature development sub-tasks as they are being generated by the large language model (e.g., sequentially) as they are being outputted by the large language model. As shown in FIGS. 5A-C, the candidate sub-task view 534 may display a title of the candidate software feature development sub-task 510 generated by the large language model. In some embodiments, the titles are selectable such that addition details associated with the candidate software feature development sub-task 510 may be rendered (e.g., via the task segmentation user interface 500 and/or or other user interfaces). Alternatively or additionally, in some embodiments, the example task segmentation user interface 500 may be configured to display selected and/or refined software feature development sub-tasks to a user. In some embodiments, the task segmentation user interface 500 may be configured to display the generative model prompt provided to and/or leveraged by the large language model to generate the candidate software feature development sub-tasks.

In some embodiments, the task segmentation user interface may include an input user interface element configured to facilitate receiving of user input. For example, in some embodiments, the task segmentation user interface may be configured to receive user input corresponding to a prompt modification request via the input user interface element. For example, in some embodiments, a user may modify the generative model prompt to re-generate candidate software feature development sub-tasks and/or generate refined software feature development sub-tasks. As another example, in some embodiments, the task segmentation user interface 500 may be configured to receive, via the input user interface element, user input corresponding to user modifications or user modification requests (e.g., user preferences, user customization, or the like) such that the user and/or the system 101 may modify candidate software feature development sub-tasks in accordance with the user input and/or other criteria to generate refined software feature development sub-tasks. In some embodiments, the input user interface element may be associated with an interaction sub-user interface 512.

In some embodiments, the task segmentation user interface 500 may include an interaction sub-user interface 512. In some embodiments, the interaction sub-user interface 512 may be rendered on the example task segmentation user interface 500 in response to a first output (e.g., a first candidate software feature development sub-task) from the large language model. Alternatively or additionally, in some embodiments, the interaction sub-user interface 512 may be rendered on the example task segmentation user interface 500 in response to indication of a selection of a candidate software feature development sub-task 510 rendered in the candidate sub-task view 534 (e.g., selection of a title of a candidate software feature development sub-task 510 rendered in the candidate sub-task view 534). In some embodiments, the interaction sub-user interface 512 may include the user input interface element as described above. As shown in FIG. 5C, the interaction sub-user interface 512 may include a title field view 536 and a description field view 538. The title field view 536 may be configured to display the title of a candidate software feature development sub-task 510 and the description field view 538 may be configured to display a corresponding description of the candidate software feature development sub-task 510. The description field view 538 may be configured such that a user may modify the description rendered therein. In some embodiments, the title field view 536 may be configured such that a user may modify the tile rendered therein. In this regard, the title field view 536 and/or description field view 538 may correspond to or otherwise may be configured to function as a user input user interface element. In some embodiments, the interaction sub-user interface 512 may include a communications user interface component 540. The communications user interface component 540 may be configured to facilitate communications between users and/or with the system 101.

The interaction sub-user interface 512 may be configured to enable a user to interact with the candidate software feature development sub-tasks as they are being generated. For example, data (title, description, or the like) associated with a candidate software feature development sub-task 510 rendered in the candidate sub-task view 534 may be rendered on the interaction sub-user interface 512, such that a user and/or the system 101 may modify the candidate software feature development sub-task 510 via the interaction sub-user interface 512 (e.g., while the large language model is still generating and/or outputting additional candidate software feature development sub-tasks for the issue document). For example, the system 101 and/or a user may leverage the interaction sub-user interface 512 to modify a title, description, or the like associated with the candidate software feature development sub-task 510.

In some embodiments, the task segmentation user interface 500 may include an information user interface element 514. The information user interface element 514 may be configured to provide information (e.g., in the text form or other suitable form) to the user, such as suggestions, options, and/or capabilities provided by the large language model and/or the system 101. For example, the information user interface element 514 may be leveraged to display to the user, an option to request regeneration of candidate software feature development sub-tasks 510. For example, the system 101 may receive indication of a request to regenerate candidate software feature development sub-tasks 510 in response to user interactions/engagement with certain user interface elements (e.g., including the segmentation request user interface element 532) configured to initiate generation of candidate software feature development sub-tasks. The new candidate software feature development sub-tasks 510 may, for example, replace the previously generated candidate software feature development sub-tasks 510.

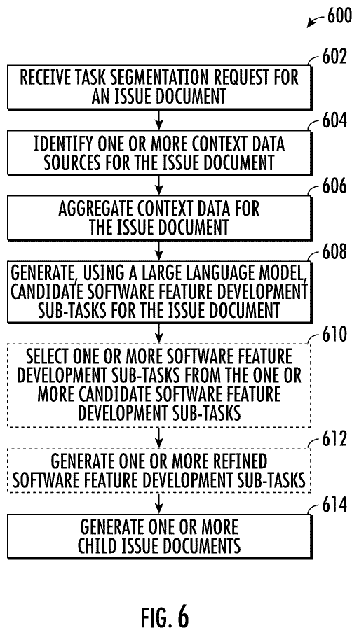

FIG. 6 is a flowchart diagram of an example process 600 for intelligent and context-aware software feature development task segmentation in accordance with at least some embodiments of the present disclosure. The process 600 may be implemented by one or more computing devices, entities, and/or systems described herein.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes at step/operation 602, receiving a task segmentation request for an issue document. For example, the apparatus 200 may receive a task segmentation request for an issue document hosted by a software application. In some embodiments, the software application may be one of one or more software applications of a multi-layer service-oriented platform. In some embodiments, the task segmentation request may include an issue document identifier for the issue document. Alternatively or additionally, in some embodiments, the task segmentation request may include the issue document.

In some embodiments, the process 600 includes at step/operation 604, identifying one or more context data sources for the issue document. For example, the apparatus 200 may identify one or more context sources for the issue document, where the one or more context data sources include the issue document and/or one or more external context data sources. In some embodiments, the apparatus 200 may identify the one or more context data sources (or a portion thereof) using a machine learning model and based on the issue document. In some embodiments, the apparatus identifies at least a portion of the one or more context data sources based on user input. In some embodiments, the user input may be received via a task segmentation user interface associated with the software application (e.g., the software application hosting the issue document).

In some embodiments, the one or more context data sources comprise a description field of the issue document. In some embodiments, the one or more context data sources comprise a summary field of the issue document. In some embodiments, the one or more context data sources comprise a domain-specific entity relation graph associated with the issue document. In some embodiments, the one or more context data sources comprise one or more content pages of a second software application associated with the software application hosting the issue document. For example, the one or more context data source may comprise one or more content pages of another software application of a multi-layer service-oriented platform associated with the software application hosting the issue document or otherwise within which the issue document was generated. In some embodiments, the one or more context data sources comprise one or more visual media objects (e.g., Loom video or the like) associated with the issue document. In some embodiments, the one or more context data sources comprise one or more other features of the software application hosting the issue document.

In some embodiments, the process 600 includes at step/operation 606, aggregating context data for the issue document based on the one or more context data sources. For example, the apparatus 200 may aggregate the context data extracted from one or more context data sources. In some embodiments, aggregating the context data may include compiling the context data extracted from the one or more context data sources and/or performing one or more preprocessing operations on the extracted context data (as described above with respect to FIG. 1). In some embodiments, where the context data source includes a domain-specific entity relation graph, aggregating the context data may include identifying one or more entities associated with the issue document by traversing the domain-specific entity relation graph, and identifying at least a portion of the context data based on entity data of the one or entities (e.g., data associated with entities such as, but not limited to, other issue documents, projects, services, incidents, post incident reviews, alerts, code deployments, code modifications, team members, and/or the like that are linked, directly or indirectly, with the issue document).

In some embodiments, where the one or more context data sources includes one or more links to one or more context pages of another software application, aggregating the context data may include accessing the one or more content pages of the software application via the one or more links and parsing the one or more content pages to identify at least a portion of the context data. In some embodiments, where the one or more context data sources includes one or more links to one or more other features of the software application hosting the issue document, aggregating the context data may include accessing the one or more other features of the software application via the one or more links and parsing the one or more features to identify at least a portion of the context data. In some embodiments, where the one or more context data sources includes one or more links to one or more visual media objects, aggregating the context data may include accessing the visual media object via the one or more links and parsing the one or more visual media objects to identify at least a portion of the context data.

In some example embodiments, the context data comprises one or more of a summary of the issue document, a description of the issue document, an issue type of issue document, parent issue data (e.g., including summary of the parent issue document, description of the parent issue document, custom fields in the parent issue document, and/or the like), child issue data, comments data, custom fields from the issue document (e.g., text that the user has configured to be added to an issue document) user data, relevant information from a knowledge base associated with the issue document, or entity data of one or more entities associated with the issue document.

In some embodiments, the process 600 includes at step/operation 608, generating, using a large language model, one or more candidate software feature development sub-tasks for the issue document. For example, the apparatus 200 may generate, using a large language model and based on the issue document and/or the context data, one or more candidate software feature development sub-tasks for the issue document by applying the issue document and the context data to the large language model. In some embodiments, where the context data includes the issue document (or a portion thereof), applying the issue document and the context data to the large language model may comprise applying the context data (which includes the issue document or portion thereof) to the large language model. In some embodiments, the large language model is a multimodal large language model.

In some embodiments, the process 600 includes at step/operation 610, selecting one or more software feature development sub-tasks from the one or more candidate software feature development sub-tasks. For example, the apparatus 200 may select one or more software feature development sub-tasks from the one or more candidate software feature development sub-tasks in response to receiving an indication of a candidate software feature development sub-task selection. In some embodiments the indication of the candidate software feature development sub-task selection is received via the task segmentation user interface. For example, the apparatus 200 may provide, via a task segmentation user interface associated with the software application hosting the issue document, the one or more candidate software feature development sub-tasks to a user. The apparatus 200 may then receive the indication of the candidate software feature development sub-task selection via the task segmentation user interface. In some embodiments, the step/operation 610 may be an optional step.

In some embodiments, the process 600 includes at step/operation 612, generating one or more refined software feature development sub-tasks. For example, the apparatus 200 may refine the one or more software feature development sub-tasks (e.g., selected in step/operation 610) or candidate software feature development sub-tasks (e.g., generated in step/operation 608) to generate one or more refined software feature development sub-tasks. In some embodiments, the apparatus 200 may generate the one or more refined software feature development sub-tasks based on user input (e.g., received via a task segmentation user interface). In some embodiments, the step/operation 612 may be an optional step.

In some embodiments, the process 600 includes at step/operation 614, generating one or more child issue documents corresponding to the one or more software feature development sub-tasks that is selected and/or refined. For example, the apparatus 200 may generate one or more child issue documents within the software application, where the one or more child issues correspond to the one or more software feature development sub-tasks selected or the one or more refined software feature development sub-tasks. For example, in some embodiments, the one or more child issue documents may comprise the one or more software feature development sub-tasks that is selected at step/operation 610. In some embodiments, the one or more child issue documents may comprise the one or more refined software feature development sub-tasks generated at step/operation 612.

In some embodiments, the apparatus 200 may receive indication of a child issue document selection. In some embodiments, the apparatus 200 may cause rendering of a user interface to a client computing device display, wherein the user interface comprises a child issue document from the one or more child issue documents corresponding to the child issue document selection.

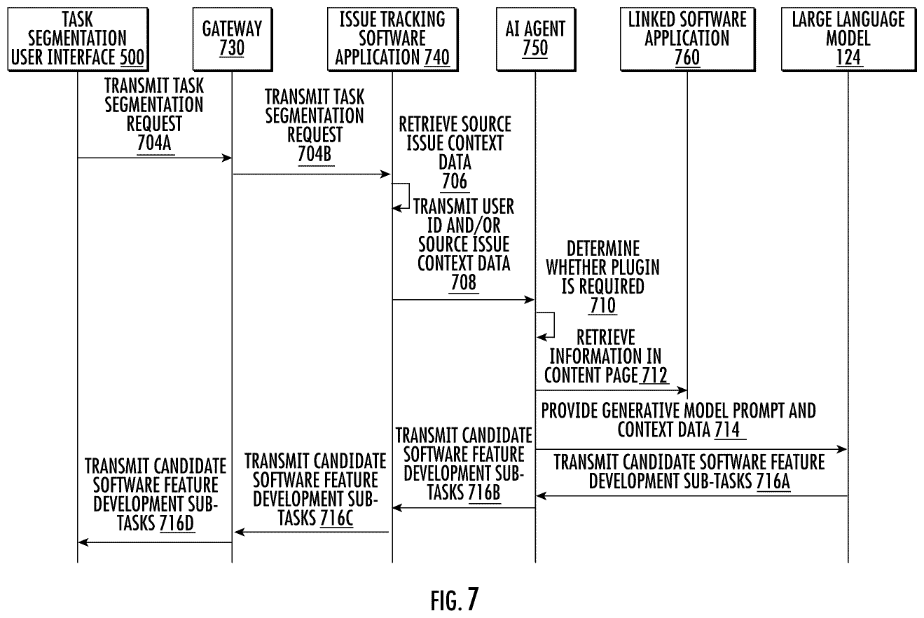

FIG. 7 illustrates an example implementation illustrating example signal diagram for intelligent and context-aware software feature development task segmentation in accordance with at least some embodiments of the present disclosure. As shown in FIG. 7, in some embodiments, a task segmentation request (such as task segmentation request 402 described above with respect to FIG. 4) for an issue document is received via a task segmentation user interface 500 and transmitted 704A to a gateway 730. In an example embodiment, the gateway 730 is a GraphQL gateway such as Atlassian GraphQL Gateway (AGG). The gateway 730 may include one or more APIs (e.g., GraphQL API or the like) configured to provide access to data and/or one or more features stored via one or more software applications supported by a multi-layer service-oriented platform. By way of example, a gateway 730, such as AGG, may be configured to provide access to Jira projects, Bitbucket repositories, Opsgenie teams, cross-product activities, or the like. The gateway 730, for example, may provide access to such data stored by the one or more software applications of the multi-layer service-oriented platform using a common mechanism. In some embodiments, the gateway 730 may be leveraged for authentication and/or authorization. The task segmentation request, for example, may originate from a user associated with a client computing device 102, via a task segmentation user interface 500 rendered on a display of the client computing device 102. The task segmentation user interface 500 may include one or more interface elements configured to cause the task segmentation request to be generated and transmitted to the gateway 730 in response to certain user interaction with the interface element (e.g., clicking or otherwise selecting the one or more interface elements).

The gateway 730 in response to satisfactory authentication and/or authorization with respect to the user and/or client computing device 102 associated with the task segmentation request may transmit 704B the task segmentation request to an issue tracking software application 740. In the example embodiment illustrated in FIG. 7, the issue tracking software application 740 may include the task segmentation system 101 (or a portion thereof) and/or associated with the task segmentation system 101. For example, the issue tracking software application 740 may embody the task segmentation system 101 (or a portion thereof). In this regard, issue tracking software application 740 may be configured to provide intelligent and context-aware software feature development task segmentation service in accordance with techniques described herein. In some embodiments, the gateway 730 includes a subscriptions feature. In such embodiments, the subscriptions feature of the gateway 730 is leveraged to stream output from the LLM (e.g., candidate software feature development sub-tasks, and/or other output from the LLM) back to the task segmentation user interface 500.

As shown in FIG. 7, source issue context data (e.g., as described above with respect to FIG. 4) is extracted or otherwise retrieved 706. The source issue context data comprise attributes of the issue document as described above with respect to FIG. 4. For example, the issue tracking software application 740 (e.g., task segmentation system 101 associated therewith) may extract or otherwise retrieve one or more of a description of the software feature development task defined by the issue document, a summary of the software feature development task defined by the issue document, an issue type of issue document, parent issue data (e.g., including summary of the parent issue document, description of the parent issue document, custom fields in the parent issue document, and/or the like), child issue data, comments data, custom fields from the issue document (e.g., text that the user has configured to be added to an issue document), user data, or other attributes of the issue document.

In the illustrated example of FIG. 7, the source issue context data is transmitted 708 to an artificial intelligence (AI) agent 750. In some embodiments a user identifier (e.g., user ID) is transmitted to the AI agent 750 along with the source issue context data. In some embodiments, The AI agent 750 corresponds to and/or includes one or more modules of the task segmentation server 106. For example, the AI agent 750 may correspond to and/or include the context extraction module 110 and/or the prediction module 114. In some embodiments, the AI agent 750 may be associated with a plugin system and may be configured to determine 710 if a plugin is required in response to receiving the source issue context data. In an example embodiment, the AI agent 750 may determine that a plugin is required if the issue document includes a link to certain external context data sources. The plugin(s) may be configured and leveraged for retrieving context data from the certain external context data sources. For example, if the issue document includes a link to an external context data source such as, for example, Confluence by Atlassian, the plugin(s) may be leveraged to retrieve content data from the confluence page and add the retrieved context data to other context data prior to providing to the LLM. Additionally, in some embodiments, plugins may be configured and leveraged for ethical filtering. For example, if the task segmentation request is considered unethical (e.g., based on one or more predetermined ethical criteria), the plugin(s) may be leveraged to prevent the LLM from generating an output for the task segmentation request (e.g., the plugin(s) may prevent the LLM from generating candidate software feature development sub-tasks). In the illustrated embodiments, the issue tracking software application (e.g., the task segmentation system 101 associated therewith) includes or is associated with the AI agent 750. The issue tracking software application (e.g., the task segmentation system 101 associated therewith) may be configured to leverage the AI agent 750 to extract context data from external context data sources (such as external context data sources 408 described above with respect to FIG. 4). The AI agent 750 may be configured to parse the issue document to determine if the issue document includes link(s) to one or more external context data sources. The AI agent 750 may be configured to access the external context data sources (e.g., via the context data source systems associated with a respective context data source) and extract or otherwise retrieve 712 relevant context data from the external context data sources in response to determining that the issue document includes one or more links.

In the illustrated example of FIG. 7, the issue document may include one or more links to one or more software applications 760 (e.g., linked software application 760) such as Confluence software application (e.g., by Atlassian, Inc.) and may retrieve information from a content page of the Confluence software application (or other linked software applications 760 in some examples). The AI agent 750 may be configured to aggregate the source issue context data and the context data retrieved from the linked software application 760 (e.g., an external data source). For example, the AI agent may augment the source issue context data with the context data retrieved from the linked software application 760 or other external data sources to enrich the source issue context data, such that a robust context data is aggregated, configured, and leveraged to improve the output of the large language model 124.

As shown in FIG. 7, a generative model prompt (as described above with respect to FIG. 4) and the aggregated context data is provided 714 to a large language model 124 configured to generate candidate software feature development sub-tasks based on the generative model prompt and aggregated context data. As shown in FIG. 7, the candidate software feature development sub-tasks may be provided to a user via the task segmentation user interface 500. For example, the candidate software feature development sub-tasks may be transmitted 716A to the AI agent. The AI agent may transmit 716B the candidate software feature development sub-tasks to the issue tracking software application 740 (e.g., to one or more modules of the task segmentation system 101 associated therewith), The issue tracking software application 740 may transmit 716C the candidate software feature development sub-tasks to the gateway 730, and the gateway 730 may transmit the candidate software feature development sub-tasks for display via the task segmentation user interface 500. In some embodiments, one or more software feature development sub-tasks is selected from the candidate software feature development sub-tasks and presented to a user via the task segmentation user interface 500. In some embodiments, the one or more software feature development sub-tasks is refined to generate one or more refined software feature development sub-tasks, and the one or more refined software feature development sub-tasks is presented to a user via the task segmentation user interface 500.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates a limited interaction mode and/or a non-limited interaction mode for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language page), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending pages to and receiving pages from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### CONCLUSION

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method for intelligent and context-aware software feature development task segmentation in a multi-layer service-oriented platform, the computer-implemented method comprising:
receiving a task segmentation request for an issue document hosted by a software application;
identifying one or more context data sources for the issue document;
aggregating context data for the issue document based on the one or more context data sources;
generating, using a large language model and based on the context data, one or more candidate software feature development sub-tasks for the issue document by applying the context data to the large language model;
selecting one or more software feature development sub-tasks from the one or more candidate software feature development sub-tasks in response to receiving an indication of a candidate software feature development sub-task selection; and
generating one or more child issue documents within the software application corresponding to the one or more software feature development sub-tasks that is selected.

2. The computer-implemented method of claim 1, wherein generating the one or more candidate software feature development sub-tasks for the issue document using the large language model comprises:
generating a few-shot model prompt comprising the context data, wherein the context data comprises at least a portion of the issue document; and
providing the few-shot model prompt to the large language model.

3. The computer-implemented method of claim 1, wherein the large language model is a multimodal large language model.

4. The computer-implemented method of claim 1, further comprising:
providing, via a task segmentation user interface associated with the software application, the one or more candidate software feature development sub-tasks to a user; and
receiving the indication of the candidate software feature development sub-task selection via the task segmentation user interface.

5. The computer-implemented method of claim 1, further comprising:
refining the one or more software feature development sub-tasks selected to generate one or more refined software feature development sub-tasks, wherein the one or more child issue documents comprises the one or more refined software feature development sub-tasks.

6. The computer-implemented method of claim 1, wherein the one or more context data sources comprise a description field of the issue document.

7. The computer-implemented method of claim 1, wherein the one or more context data sources comprise a domain-specific entity relation graph associated with the issue document.

8. The computer-implemented method of claim 7, wherein aggregating the context data comprises:
identifying one or more entities associated with the issue document by traversing the domain-specific entity relation graph; and
identifying at least a portion of the context data based on entity data of the one or entities.

9. The computer-implemented method of claim 1, wherein the one or more context data sources comprise one or more content pages of a second software application associated with the software application hosting the issue document.

10. The computer-implemented method of claim 9, wherein the issue document comprises one or more links to the one or more content pages of the second software application, wherein aggregating the context data comprises:
accessing the one or more content pages of the software application via the one or more links; and
parsing the one or more content pages to identify at least a portion of the context data.

11. The computer-implemented method of claim 1, wherein the one or more context data sources comprise one or more visual media objects associated with the issue document.

12. The computer-implemented method of claim 1, wherein identifying the one or more context data sources comprises:
identifying at least a portion of the one or more context data sources using a machine learning model and based on the issue document.

13. The computer-implemented method of claim 1, wherein identifying the one or more context data sources comprises:
identifying at least a portion of the one or more context data sources based on user input, wherein the user input is received via a task segmentation user interface associated with the software application.

14. The computer-implemented method of claim 1, wherein the context data comprises one or more of (i) a summary of the issue document, (ii) a description of the issue document, (iii) an issue type of issue document, (iv) parent issue data, (v) user data, or (vii) entity data of one or more entities associated with the issue document.

15. The computer-implemented method of claim 1, further comprising:
receiving indication of a child issue document selection; and
causing rendering of a user interface to a client computing device display, wherein the user interface comprises a child issue document from the one or more child issue documents corresponding to the child issue document selection.

16. An apparatus for intelligent and context-aware software feature development task segmentation in a multi-layer service-oriented platform, the apparatus comprising at least one processor and at least one memory including program code, the at least one memory and the program code configured to, with the at least one processor, cause the apparatus to at least:
receive a task segmentation request for an issue document hosted by a software application;
aggregate context data for the issue document based on the issue document and one or more external context data sources associated with the issue document;
generate, using a large language model and based on the context data, one or more candidate software feature development sub-tasks for the issue document by applying the context data to the large language model; and
generate one or more child issue documents within the software application corresponding to the one or more candidate software feature development sub-tasks.

17. The apparatus of claim 16, wherein the at least one memory and the program code configured to, with the at least one processor, cause the apparatus to generate the one or more candidate software feature development sub-tasks for the issue document using the large language model by:
generating a few-shot model prompt comprising the context data; and
providing the few-shot model prompt to the large language model.

18. The apparatus of claim 16, wherein the large language model is a multimodal large language model.

19. The apparatus of claim 16, wherein the one or more context data sources comprise a description field of the issue document.

20. At least one non-transitory computer-readable storage medium for intelligent and context-aware software feature development task segmentation in a multi-layer service-oriented platform, the at least one non-transitory computer-readable storage medium having computer coded instructions configured to, when executed by at least one processor:
receive a task segmentation request for an issue document hosted by a software application;
aggregate context data for the issue document based on the issue document and one or more external context data sources associated with the issue document;
generate, using a large language model and based on the context data, one or more candidate software feature development sub-tasks for the issue document by applying the context data to the large language model;
generate one or more refined software feature development sub-tasks based on the one or more candidate software feature development sub-tasks; and
generate one or more child issue documents within the software application corresponding to the one or more refined software feature development sub-tasks.
